(19) United States
(12) Patent Application Publication
(10) Pub. No.: US 2023/0326197 A1
(43) Pub. Date: Oct. 12, 2023

(54) TECHNOLOGY TO CONDUCT CONTINUAL LEARNING OF NEURAL RADIANCE FIELDS

(71) Applicant: Intel Corporation, Santa Clara, CA (US)

(72) Inventors: Zhipeng Cai, Santa Clara, CA (US); Matthias Mueller, Munich (DE)

(21) Appl. No.: 18/332,992

(22) Filed: Jun. 12, 2023

Related U.S. Application Data
(60) Provisional application No. 63/495,483, filed on Apr. 11, 2023.

(51) Int. Cl. G06V 10/82; H04N 13/106

(52) U.S. Cl. CPC G06V 10/82; H04N 2013/0092; H04N 13/106

(57) ABSTRACT

Systems, apparatuses and methods may provide for technology that trains a first neural radiance field (NeRF) model with first images corresponding to a first instance of a scene, detects second images corresponding to a second instance of the scene, and applies generative replay and the second images to the first NeRF model to obtain a second NeRF model, wherein one or more of appearance changes or geometry changes in the second instance of the scene relative to the first instance of the scene are incorporated into the second NeRF model.

### CROSS-REFERENCE TO RELATED APPLICATIONS

The present application claims the benefit of priority to U.S. Provisional Patent Application No. 63/495,483, filed on Apr. 11, 2023.

### TECHNICAL FIELD

Embodiments generally relate to machine learning and computer vision technology. More particularly, embodiments relate to machine learning and computer vision technology to conduct continual learning of neural radiance fields (NeRFs).

### BACKGROUND

Neural Radiance Fields (NeRFs) are techniques to render novel (e.g., unseen) views given a set of multi-view images of a scene. The continual learning problem of NeRFs aims to address the case where new scans of the scene are generated continually over time, with potential rendering coverage, scene appearance or geometry changes in different scans. Conventional NeRF solutions may be subject to information loss (e.g., “forgetting”) and/or slow during operation.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The various advantages of the embodiments will become apparent to one skilled in the art by reading the following specification and appended claims, and by referencing the following drawings, in which:

FIGS. 1A-1E are illustrations of an example of a set of view renderings according to an embodiment;

FIG. 2A is a block diagram of an example of a model update according to an embodiment;

FIG. 2B is a block diagram of an example of a replay buffer update according to an embodiment;

FIG. 2C is a block diagram of an example of an architecture that includes segmentation masks and trainable embeddings according to an embodiment;

FIG. 3 is a comparative illustration of an example of conventional view renderings and enhanced view renderings according to an embodiment;

FIG. 4 is a comparative plot of an example of conventional replay buffer size results and enhanced replay buffer size results according to an embodiment;

FIG. 5 is a flowchart of an example of a method of operating a performance-enhanced computing system according to an embodiment;

FIG. 6 is a block diagram of an example of a performance-enhanced computing system according to an embodiment;

FIG. 7 is an illustration of an example of a semiconductor package apparatus according to an embodiment;

FIG. 8 is a block diagram of an example of a processor according to an embodiment; and

FIG. 9 is a block diagram of an example of a multi-processor based computing system according to an embodiment.

### DETAILED DESCRIPTION

Overview

The technology described herein provides the ability of a NeRF model to learn continually from new scans, without forgetting (e.g., being able to render old scene appearance or geometry), with minimum storage requirements, and without storing historical images. The problem solved by the technology described herein is common in many applications such as three-dimensional (3D) house demonstrations/city rendering, where the house/city being rendered changes over time. The ability to quickly adapt to these changes while being able to still render the old house/city, without the need to store all historical images, is useful in large scale applications under storage constraints.

Traditionally, MEIL-NeRF (Memory Efficient Incremental Learning NeRF) has been one approach that uses NeRFs to synthesize historical training data in an effort to prevent forgetting. Disadvantages of MEIL-NeRF include:
1. MEIL-NeRF has a complex design of the system, including complex loss functions, biased sampling and trained historical camera ray generators. These components make the method perform poorly in terms of preventing forgetting and introduce new hyper-parameters that may not generalize to more recent NeRF architectures (e.g., MEIL-NeRF is designed on “vanilla” NeRF only).
2. MEIL-NeRF can handle only static scenes (e.g., not applicable to scenes with appearance and geometry changes).
3. MEIL-NeRF is slow during continual learning, because the solution is designed using a vanilla NeRF architecture, which is slow for training and has heavy overhead for generating historical images.

The technology described herein prevents forgetting without storing historical data, by applying generative replay, where instead of storing all historical images, the historical images are generated using previously deployed models whenever the model is updated on new data. Embodiments apply an advanced Instant-NGP (Instant Neural Graphics Primitives) architecture to the system, making the system fast for generative replay and model updates. Embodiments also add trainable embeddings to the model architecture, so that a single model can handle changing scene appearance and geometry over time, and the model size does not increase significantly over time. Additionally, embodiments handle transient objects using segmentation masks, so that the system can be applied to “in-the-wild” photos (e.g., images of uncontrolled scenes).

Accordingly, the technology described herein lowers storage consumption and enables the system to be flexibly applied to applications with various storage limits, even when no historical images can be stored. The technology described herein also provides high rendering quality. Indeed, the resulting model performs close to the upper bound (UB) model that trains on all data at once (e.g., store all historical data and retrain the model from scratch whenever new data is received, which introduces heavy storage consumptions).

At a higher level, the technology described herein is a modular solution that trains a neural radiance field and then uses generative replay to distill the neural radiance field into a new model along with images captured from a new scene. At a lower level, logs and/or decompiled software demonstrate a unique structure, taxonomy and/or neural network output evolution. Additionally, a trained model as described herein has a robust response to varying noisy inputs. Indeed, the use of continual learning in combination with neural radiance field updates as described herein is a unique and advantageous solution.

### Problem Definition

NeRF: NeRFs are models used to render novel (e.g., unseen, previously unrendered) views from a set of images capturing on the same scene.

Given a set of images, NeRFs train a model parameterized by θ that maps a three-dimensional (3D) location x∈R³ and a view direction d∈S³ (e.g., a unit vector from the camera center to x) to the corresponding color c(x,d|θ)∈[0,1]³ and opacity σ(x|θ)∈[0,1]. Given a target image view, the color for each pixel is rendered independently. For each pixel, a ray is cast from the camera center o∈R³ towards the pixel center, and a set of 3D points X={xᵢ|xᵢ=o+τᵢd} is sampled along the ray, where τᵢ is the euclidean distance from the camera center to the sampled point. Then, the color Ĉ(X) of the ray is rendered following a volume rendering equation:

$$\hat{C} ( X ) = {\sum }_{i} {ω}_{i} c ( {x}_{i} , d \vert θ ) , \qquad ( 1 )$$

$$where$$

$${w}_{i} = {e}^{- {\sum }_{j = 1}^{i - 1} σ ( {x}_{j} \vert θ ) ( {τ}_{j + 1} - {τ}_{j} )} ( 1 - {e}^{- σ ( {x}_{i} \vert θ ) ( {τ}_{i + 1} - {τ}_{i} )} ) .$$

Intuitively, equation (1) computes the weighted sum of the colors on all sampled points. The weights wᵢ are computed based on the opacity and the distance to the camera center.

In continual learning of NeRFs (continual NeRF), at each time step t:
1. A set of training images along with their respective camera parameters (e.g., intrinsics and extrinsic s) Sₜ are generated.
2. The current model θₜ and the replay buffer Mₜ (for storing historical data) are updated by:

{Mₜ,θₜ}←update(Sₜ,θₜ₋₁,Mₜ₋₁), (2)
3. θₜ is deployed for rendering novel views until t+1.

This process simulates the practical scenario where the model θₜ is deployed continually. When a set of new images arrives, potentially containing new views of the scene and changes in appearance or geometry, the goal is to update θₜ, while keeping storage (e.g., to maintain historical data in Mₜ) and memory (e.g., to deploy θₜ requirements small.

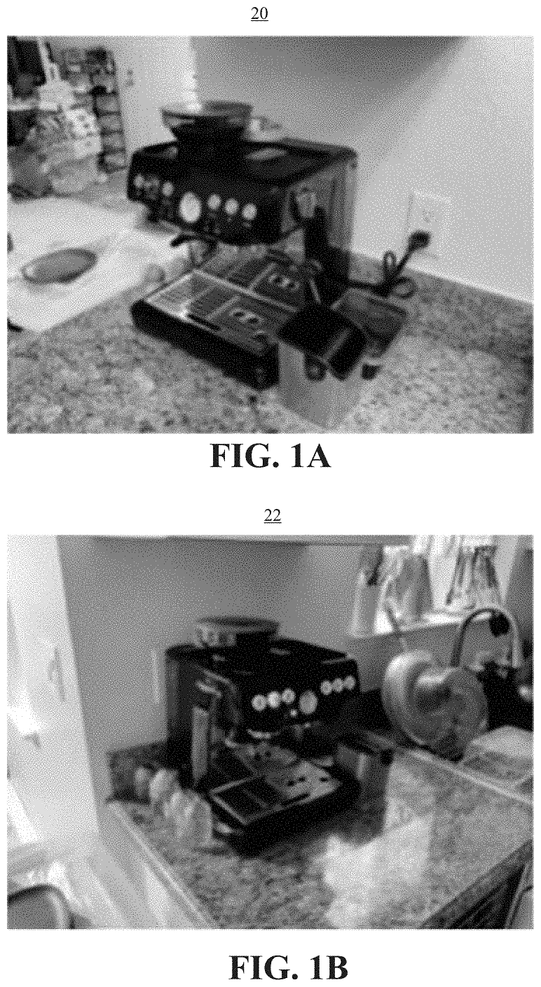

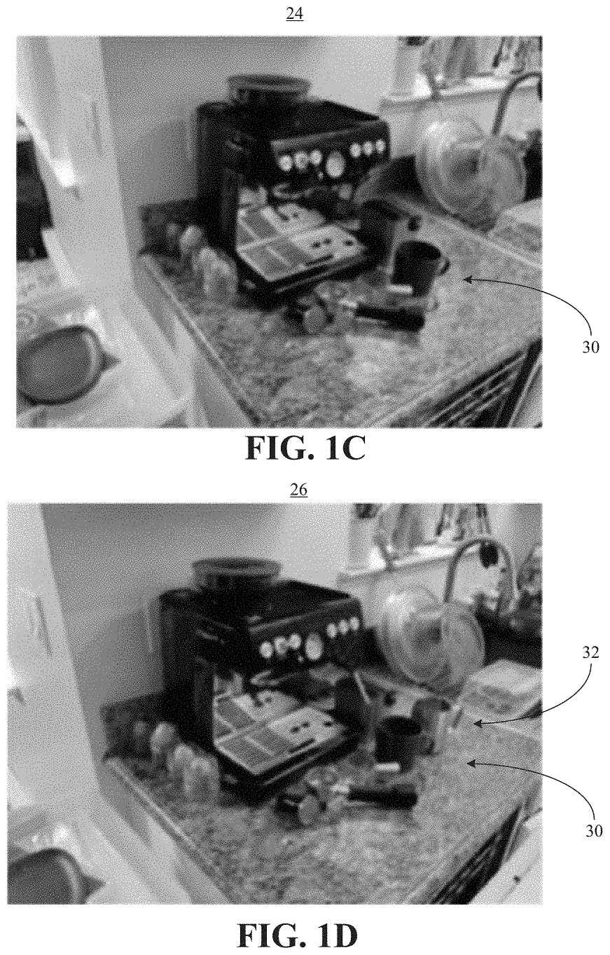

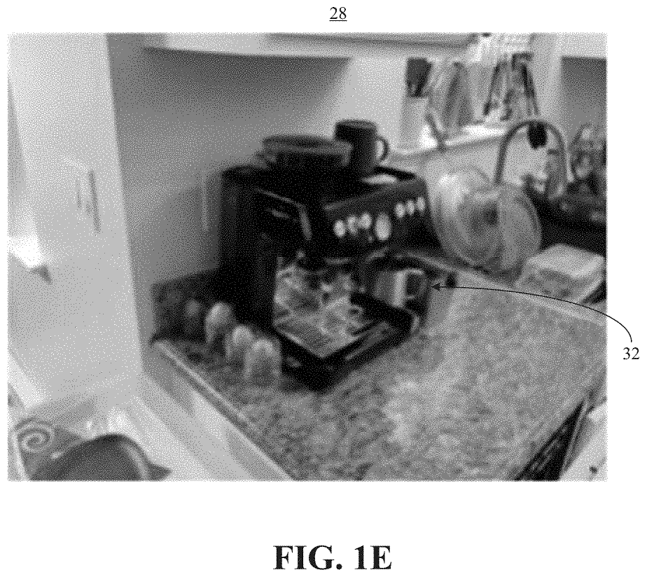

Turning now to FIGS. 1A-1E, a set of view renderings includes a first view rendering 20 (e.g., first instance at time t=1), a second view rendering 22 (e.g., second instance at time t=2), a third view rendering 24 (e.g., third instance at time t=3), a fourth view rendering 26 (e.g., fourth instance at time t=4), and a fifth view rendering 28 (e.g., fifth instance at time t=5) of a scene are shown. In general, at each time step t, a new set of training images are received/detected, wherein the new set of training images are used to update the NeRF model. In between two time steps t and t+1, there can be a period of time where no training images are received and the most recently updated model is used to render arbitrarily many novel views. Thus, the NeRF model that is updated at time t=5 can be used to render all of the view renderings 20, 22, 24, 26, 28. More generally, at time step t, the current NeRF model is able to render novel views for scenes at time step from 1 to t.

In the illustrated example, the first view rendering 20 is generated (e.g., for time t=1) from a first point of view (e.g., right side perspective of a coffee machine) based on a first scan/set of multi-view images (e.g., training images/data) and a first NeRF. The first point of view may be considered novel because the first point of view was not present in the first set of multi-view images (e.g., none of the cameras used to conduct the first scan aligned with the first point of view). Additionally, the second view rendering 22 is generated (e.g., for time t=2) from a second point of view (e.g., left side perspective of the coffee machine) based on a second (e.g., updated) NeRF. In an embodiment, the second view rendering 22 is generated independently of the first view rendering 20 (e.g., solely based on the second NeRF) and the second NeRF is generated based on a second scan/set of multi-view images (e.g., training images) and the first NeRF. The second point of view may be considered a novel view because the second point of view was not present in the second set of multi-view images used to obtain the second NeRF. Of particular note is that an appearance change has occurred in the scene from time t=1 to time t=2. More particularly, the lighting conditions for the coffee machine in the second instance of the scene (e.g., based on the second scan) are darker than the lighting conditions in the first instance of the scene (e.g., in the first scan). The technology described herein incorporates the appearance change (e.g., darker lighting) into the second view rendering 22 without losing (e.g., forgetting) other information regarding the coffee machine.

In an embodiment, the third view rendering 24 is generated (e.g., for time t=3) from the second point of view based on a third (e.g., further updated) NeRF, wherein the third NeRF is generated based on a third scan/set of multi-view images (e.g., training images) and the second NeRF. In the illustrated example, an appearance change and a geometry change have occurred in the scene from time t=2 to time t=3. More particularly, the lighting conditions for the coffee machine in the third instance of the scene are brighter than the lighting conditions in the second instance of the scene. Additionally, extra coffee machine components 30 are present in the third instance of the scene relative to the second instance of the scene. The technology described herein incorporates the brighter lighting conditions and the extra coffee machine components 30 (e.g., geometry change) into the third view rendering 24 without losing (e.g., forgetting) other information regarding the coffee machine.

The fourth view rendering 26 is generated (e.g., for time t=4) from the second point of view based on a fourth (e.g., further updated) NeRF, wherein the fourth NeRF is generated based on a fourth scan/set of multi-view images (e.g., training images) and the third NeRF. In the illustrated example, a geometry change has occurred in the scene from time t=3 to time t=4. More particularly, an additional coffee mug 32 is present in the fourth instance of the scene relative to the third instance of the scene. The technology described herein incorporates the additional coffee mug 32 into the fourth view rendering 26 without losing (e.g., forgetting) other information regarding the coffee machine.

The fifth view rendering 28 is generated (e.g., for time t=5) from the second point of view based on a fifth (e.g., further updated) NeRF, wherein the fifth NeRF is generated based on a fifth scan/set of multi-view images (e.g., training images) and the fourth NeRF. In the illustrated example, a geometry change has occurred in the scene from time t=4 to time t=5. More particularly, a mug of the extra coffee machine components 30 has been placed on top of the coffee machine, the remaining extra coffee machine components 30 have been removed, and the additional coffee mug 32 has been moved to a different location. The technology described herein incorporates the geometry changes into the fifth view rendering 28 without losing (e.g., forgetting) other information regarding the coffee machine.

Enhanced Solution

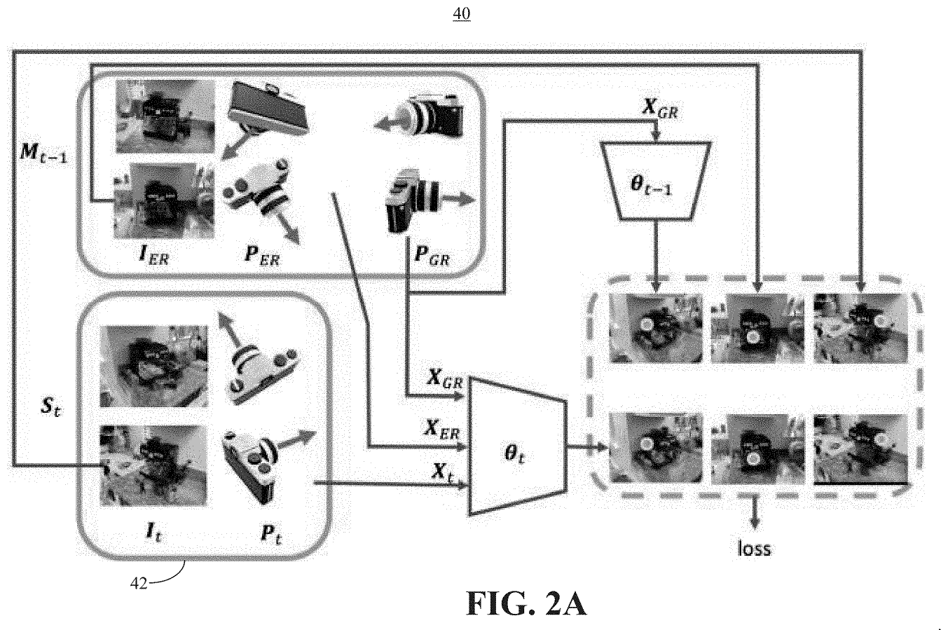

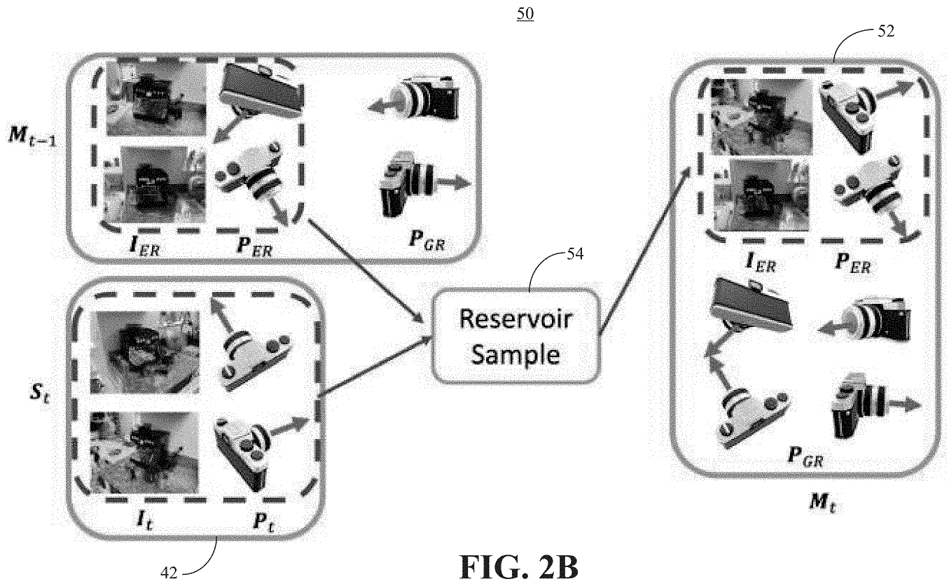

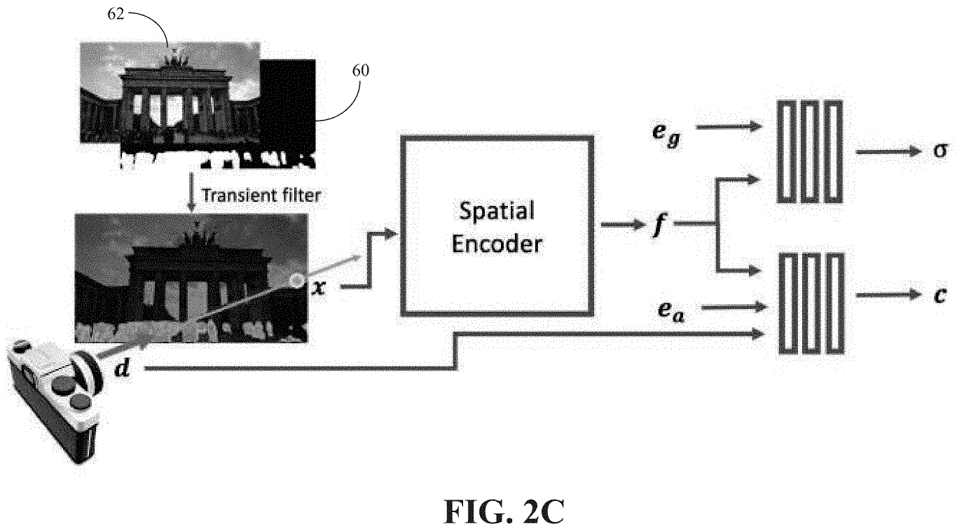

With continuing reference to FIGS. 2A-2C a model update 40 is shown for a CLNeRF system as described herein. In the illustrated example, at each time step t of continual NeRF, a new set of data 42 (Sₜ) is generated. To update the model θₜ, a set of camera rays is randomly generated in each training iteration from camera parameters stored for experience replay (P_{ER}), generative replay (P_{GR}) and in the new data (Pₜ). For rays from new data (Xₜ) or experience replay (X_{ER}), the corresponding image color is used for supervision. For rays from generative replay (e.g., X_{GR}), the latest deployed model θₜ₋₁ is used to generate pseudo-labels for supervision. After training θₜ, the previously deployed model θₜ₋₁ is replaced with θₜ, and the replay buffer Mₜ is updated.

As best shown in FIG. 2B, an update 50 of a replay buffer 52 (Mₜ) may be conducted under optional experience replay. In the illustrated example, reservoir sampling 54 is performed over image-camera-parameter pairs in Mₜ₋₁ and Sₜ, and added into P_{GR} camera parameters for all images not selected by the reservoir sampling 54. In general, the reservoir sampling 54 includes a family of randomized procedures to choose a simple random sample, without replacement, of k items from a population of unknown size n in a single pass over the items. The size of the population n is typically too large to fit into main memory.

As best shown in FIG. 2C, segmentation masks 60 may be used to filter transient objects (e.g., pedestrians) from a scene 62. Additionally, embodiments apply appearance embeddings eₐ and geometry embeddings e_{g} to the base architecture to handle scene changes at different time steps.

Model Update

When new data arrives, the camera parameters of all historical images are stored in the replay buffer Mₜ₋₁ for generative replay. A small number of images I_{ER} may be optionally stored when the storage is sufficient to enable experience replay. At each training iteration of θₜ, CLNeRF generates a batch of camera rays X=X_{ER}∪X_{GR}∪Xₜ uniformly from Pₜ∪P_{ER}∪P_{GR}, where Pₜ, P_{GR} and P_{ER} are, respectively, the camera parameters of new data 42 Sₜ, generative replay data and experience replay data. The training objective for CLNeRF is

$${minimize}_{{θ}_{i}} \frac{{\sum }_{X ∈ 𝒳} {ℒ}_{NeRF} ( 𝒞 ( X ) , \hat{𝒞} ( X \vert {θ}_{t} ) )}{\vert 𝒳 \vert} , \qquad ( 3 )$$

where [symbol] _{NeRF} is the loss for normal NeRF training, C(⋅) is the supervision signal from new data or replay, and Ĉ(⋅|θₜ) is the color rendered by θₜ. For the rays X∈X_{GR} sampled from P_{GR}, generative replay is performed (e.g., the supervision signal C(X) is set as the image colors Ĉ(X|θₜ₋₁) generated by θₜ₋₁. For the other rays, C(X) is the ground-truth image color. After the model update 50, the previously deployed model θₜ₋₁ is replaced with θₜ and the replay buffer 52 Mₜ is updated. Only θₜ and n are maintained until the next set of data Sₜ₊₁ arrives.

Although all camera parameters are stored in Mₜ₋₁, the camera parameters only consume a small amount of storage, at most Nₜ₋₁(dₚₒₛₑ+dᵢₙₜ), where Nₜ₋₁ is the number of historical images, dₚₒₛₑ and dᵢₙₜ are the dimensions of camera poses and intrinsic parameters, respectively. In one example, dₚₒₛₑ=6 and dᵢₙₜ≤5 for common camera models. Additionally, dᵢₙₜ may be shared if multiple images are captured by the same camera. As a concrete example, storing the parameters for 1000 samples (e.g., each captured with a different camera) involves roughly 45 KB of storage, which is much less than storing a single high resolution image. Such an approach guarantees the effectiveness of CLNeRF even on applications with limited storage. During random sampling, uniform weights are assigned to all views (historical and new) revealed so far, which is advantageous for preventing forgetting during continual learning.

Replay Buffer Update

In the extreme case where no image can be stored for experience replay, only the camera parameters of historical data in Mₜ are stored. When the storage is sufficient to maintain a subset of historical images for experience replay, a reservoir buffer is used. Specifically, current data is added to Mₜ as long as the storage limit is not reached. Otherwise, as best seen in FIG. 2B, given that Mₜ₋₁ is capable of storing K images, for each image Iᵢ∈Sₜ a random integer jᵢ∈{1, 2, . . . , Nᵢ} is first generated, where Nᵢ represents the order of Iᵢ in the continual learning data sequence. If jᵢ>K, Iᵢ is not added into Mₜ. Otherwise, the jᵢ'th image in Mₜ₋₁ is replaced with Iᵢ. In one example, Mₜ stores all camera parameters regardless of whether the corresponding image is stored.

Architecture

An Instance-NGP model may be used as the base model of CLNeRF, so that the model update and generative replay are efficient. Additionally, a trainable appearance embedding eₐ and a trainable geometry embedding e_{g} are added into the base architecture to handle changing scenes. Specifically, one trainable appearance and geometry embedding are added into the model whenever the new data contains scene changes. In one example, the dimension of appearance embedding is set to forty-eight and geometry embedding is set to sixteen. If appropriate, segmentation masks 60 (e.g., from DeepLabv3) can be used to filter out transient objects such as pedestrians and vehicles.

Results

CLNeRF is compared to: (1) Naive Training (NT), where a model is trained sequentially on new data without continual learning. NT represents the lower-bound performance that can be achieved on continual NeRF; (2) Elastic Weight Consolidation (EWC), a widely-used regularization-based continual learning method; (3) Experience Replay (ER), one of the most effective continual learning methods; (4) MEIL-NeRF, a concurrent work that may also use generative replay. For fair comparison, the ground-truth camera parameters are used to generate replay camera rays for MEIL-NeRF as done in CLNeRF, rather than using a small MLP to learn the rays of interests. This strategy makes the implementation simpler and performs better; and (5) The upper bound model (UB) trained on all data at once, representing the upper-bound performance of continual NeRF. For all methods that involve experience replay (ER and CLNeRF), ten images were permitted to be stored in the replay buffer to simulate the case of highly limited storage. Additionally, the best-performing architecture was chosen for each approach.

EWC and ER are classic continual learning methods designed for image classification. MEIL-NeRF may be a concurrent work also using generative replay for NeRFs.

CLNeRF can be compared over multiple datasets, including standard NeRF datasets with only static scenes (Synth-NeRF, NeRF++, NSVF, Phototourism), and another dataset with scene geometry and appearance change over time (WOT). As shown in Tables I(a) and I(b), CLNeRF performs significantly better than other continual learning methods for NeRFs, even without storing any historical images (CLNeRF-noER). Indeed, CLNeRF can produce close to upper bound (UB) performance. Having a small number of images (e.g., ten) stored in the replay buffer can further bridge the gap between CLNeRF and the upper bound model.

TABLE I(a)

| | Dataset | | | |
|---|---|---|---|---|
| Method | Synth-NeRF | NeRF++ | NSVF | WOT |
| NT (NeRF) | 28.53/0.938 | 14.81/0.462 | 18.58/0.768 | 16.70/0.649 |
| EWC (NeRF) | 28.32/0.925 | 15.03/0.442 | 18.12/0.778 | 16.29/0.672 |
| ER (NeRF) | 30.29/0.948 | 17.35/0.542 | 26.51/0.902 | 21.36/0.709 |
| MEIL-NeRF | 30.69/0.953 | 19.40/0.595 | 27.19/0.909 | 24.05/0.730 |
| (NGP) | | | | |
| CLNeRF-noER | 31.96/0.956 | 20.31/0.632 | 29.32/0.924 | 25.44/0.762 |
| (NGP) | | | | |
| CLNeRF | 32.16/0.957 | 20.33/0.634 | 29.48/0.923 | 25.45/0.764 |
| (NGP) | | | | |
| UB (NGP) | 32.94/0.959 | 20.34/0.648 | 30.28/0.931 | 25.85/0.767 |

TABLE I(b)

| | Dataset |
|---|---|
| Method | Phototourism |
| NT (NGP) | 19.28/0.692 |
| ER (NGP) | 20.03/0.713 |
| MEIL-NeRF (NGP) | 22.35/0.746 |
| CLNerf-noER (NGP) | 22.67/0.751 |
| CLNerf (NGP) | 22.88/0.752 |
| UB (NeRFW) | 22.78/0.823 |
| UB (NGP) | 23.05/0.763 |

The results are in the form of peak signal to noise ratio (PSNR) and structural similarity index measure (SSIM), with the best performing solution in bold. Each solution is labeled with the best performing architecture (e.g., vanilla) NeRF or NGP (neural graphics primitives). CLNeRF performs the best among all continual NeRF approaches and across all datasets, even without storing any historical images (CLNeRF-noER). The performance gap between CLNeRF and the upper-bound model UB remains low for all datasets. All competitors are equipped with trainable embeddings for fairer comparison to CLNeRF. Without using the embeddings on WOT, the performance gap between these approaches and CLNeRF increases significantly (e.g., NT: 16.17/0.625, EWC: 15.81/0.650, ER: 17.99/0.666, MEIL-NeRF: 20.92/0.720). On Phototourism, the performance difference across approaches is much less due to the random division of time steps (e.g., making pose and appearance distributions similar over time) and CLNeRF still performs close to the upper-bound model. UB with NeRFW performs worse than UB with NGP in terms of PSNR but better in terms of SSIM

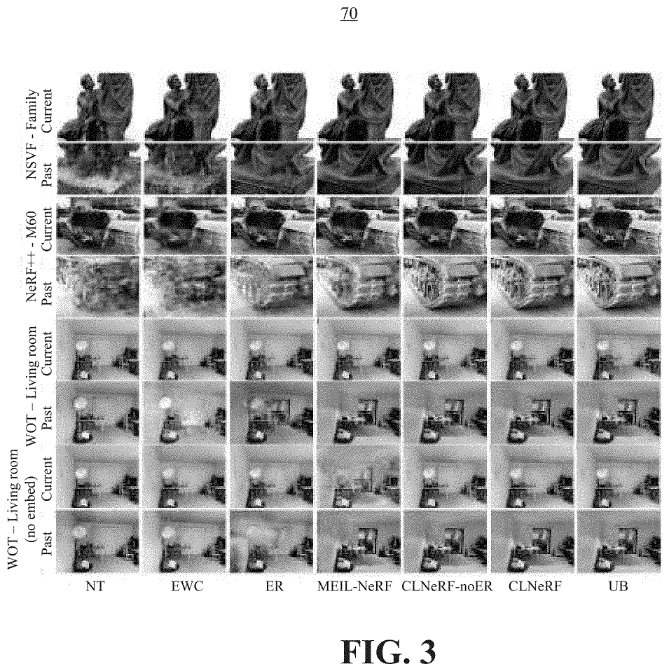

FIG. 3 shows qualitative results for a set of view renderings 70. In the illustrated example, each two rows show the (zoom-in) test views of the current and past scans rendered by different solutions. CLNeRF has a similar rendering quality as UB, even without storing any historical images. NT overfits to the new data, resulting in erroneous renderings for early scans. The regularization from EWC not only hinders the model from adapting to new data but also fails to recover the old scene appearance/geometry. Blur and artifacts appear on images rendered by ER and MEIL-NeRF, especially in early scans, due to the lack of enough replay data (ER), the biased sampling and loss function design (MEIL-NeRF). Without using the trainable embeddings proposed in CLNeRF (WOT-Living room (noEmbed)), other continual NeRF approaches perform much worse on WOT. Thus, other continual NeRF methods produce severe artifacts, incorrect appearance, or geometry especially for past time steps of the scene.

Table II also shows ablation study results in which all CLNeRF components are effective in improving performance. In general, ablation is the removal of a component of an artificial intelligence (AI) system. An ablation study therefore investigates the performance of an AI system by removing certain components to understand the contribution of the component to the overall system.

TABLE II

Dataset

| Method | Synth-NeRF | WOT |
|---|---|---|
| CLNeRF | 32.16/0.957 | 25.45/0.764 |
| No ER | 31.96/0.957 | 25.44/0.762 |
| No GenRep | 27.35/0.919 | 18.52/0.634 |
| No NGP | 29.23/0.940 | 23.50/0.728 |
| No Embed | N.A. | 21.09/0.725 |
| No Reinit | NaN | NaN |

The performance of CLNerf drops slightly without ER, but significantly without generative replay (No GenRep) or the use of the NGP architecture. Without using the trainable embeddings (No Embed), CLNeRF performs much worse under the appearance and geometry changes of WOT. Because Synth-NeRF has only static scenes, no trainable embeddings are involved. Without re-initialization (No Reinit), the NGP architecture leads to NaN-loss when training iterations increase.

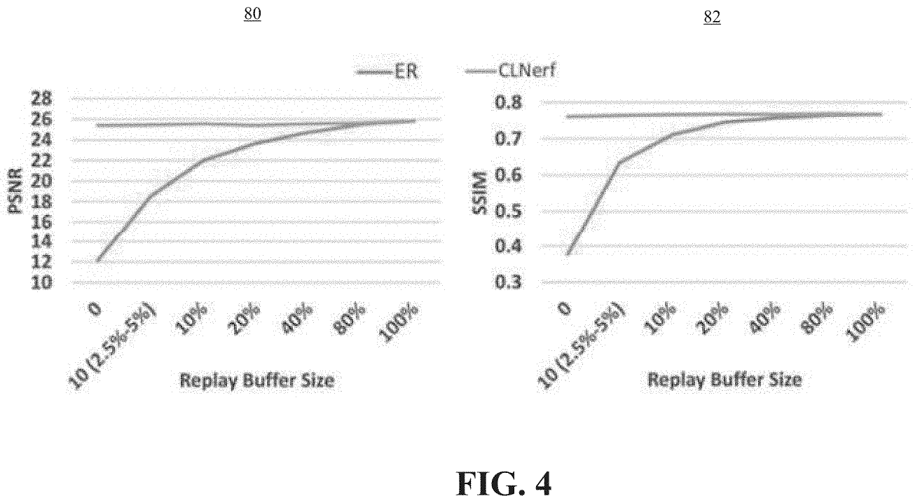

FIG. 4 shows a PSNR plot 80 and a SSIM plot 82 that demonstrate the effect of replay buffer sizes (e.g., how the performance will change if different numbers of historical images are stored in the replay buffer). The performance of CLNeRF remained high for all replay buffer sizes, while the classical continual learning method experience replay (ER) performed badly when the replay buffer size is small. More particularly, ER on NGP requires a replay buffer size of more than 80% of the dataset size to perform on-par with CLNerf. In the illustrated example, 80% corresponds to almost all historical data before the current time step, since all data from the current time step are always available. Moreover, “10(2.5%-5%)” indicates that ten images are permitted to be stored in the replay buffer, which is roughly 2.5%-5% of all images of a scene. By contrast, “10%” indicates that the replay buffer is permitted to store “10%” of all images from the same scene.

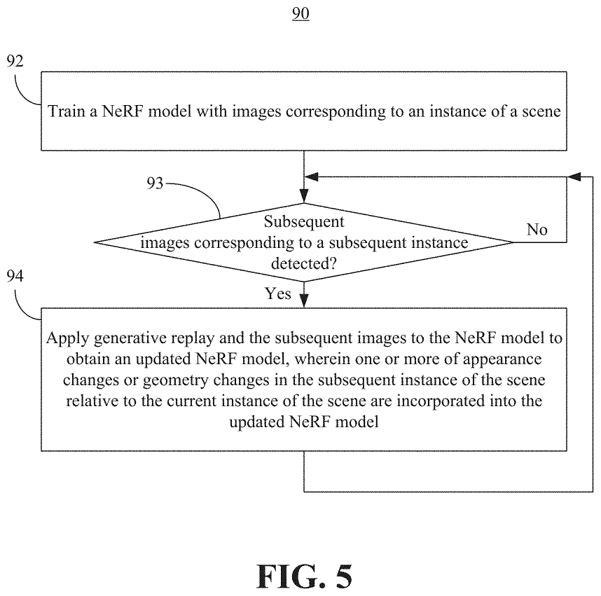

FIG. 5 shows a method 90 of operating a performance-enhanced computing system. The method 90 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 90 can be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 92 trains a NeRF model with images (e.g., first multi-view images) corresponding to an instance of a scene. In an embodiment, block 92 bypasses a storage of the first images after the first NeRF is trained. Block 93 determines whether subsequent images corresponding to a subsequent instance have been detected. If not, the method 90 waits until the subsequent images have been detected. Once the subsequent images have been detected, block 94 applies generative replay and the subsequent images (e.g., second multi-view images) to the NeRF model to obtain an updated (e.g., second) NeRF model. In the illustrated example, one or more of appearance changes or geometry changes in the second instance of the scene relative to the first instance of the scene are incorporated into the updated NeRF model. In one example, the first NeRF is trained further based on camera parameters associated with the first images. In such a case, block 94 may incorporate the camera parameters into the generative replay. Additionally, block 94 may add trainable embeddings to the updated NeRF model, wherein the trainable embeddings handle at least one of the appearance change(s) or geometry change(s). Block 94 may also apply segmentation masks to transient objects in the second and/or subsequent instances of the scene. In an embodiment, block 94 bypasses a storage of the first NeRF model and the subsequent images after the updated NeRF model is obtained. The method 90 then returns to block 93 to wait for the next (e.g., third, fourth, etc.) set of images (e.g., continual learning). The method 90 therefore enhances performance at least to the extent that using NeRF models and generative replay to support appearance changes and/or geometry changes over time reduces storage consumption and/or increases rendering quality.

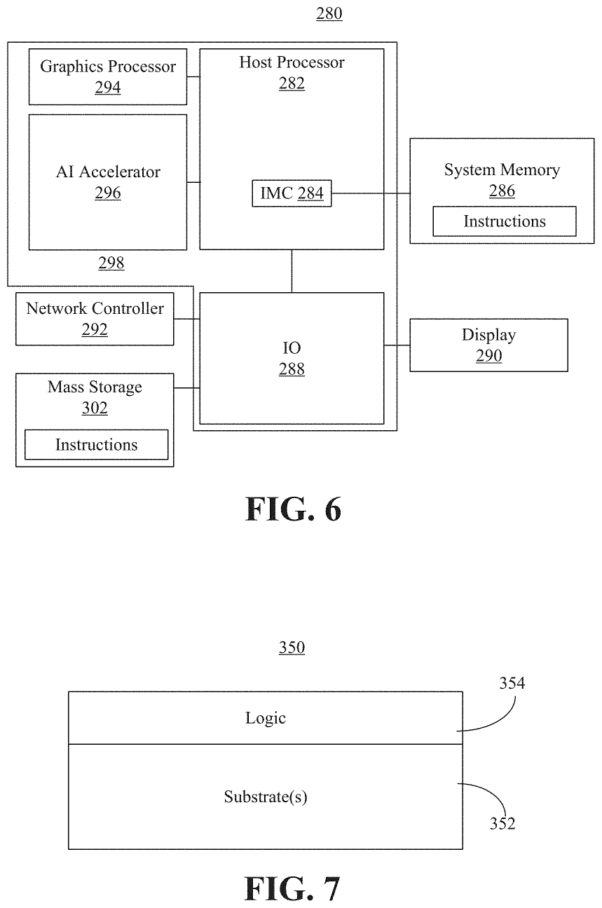

Turning now to FIG. 6, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including dynamic RAM/DRAM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 (e.g., specialized processor) into a system on chip (SoC) 298.

In an embodiment, the AI accelerator 296 and/or the host processor 282 execute instructions 300 retrieved from the system memory 286 and/or the mass storage 302 to perform one or more aspects of the method 90 (FIG. 5), already discussed. Thus, execution of the instructions 300 causes the AI accelerator 296, the host processor 282 and/or the computing system 280 to train a NeRF model with images corresponding to an instance of a scene and detect second images corresponding to a second instance of the scene. Execution of the instructions 300 also causes the AI accelerator 296, the host processor 282 and/or the computing system to apply generative replay and the second images to the NeRF model to obtain a second NeRF model. One or more of appearance changes or geometry changes in the second instance of the scene relative to the first instance of the scene are incorporated into the second NeRF model. Execution of the instructions 300 may be repeated for third images, fourth images, fifth images, etc., over time. The computing system 280 is therefore considered performance-enhanced at least to the extent that using NeRF models and generative replay to support appearance changes and/or geometry changes over time reduces storage consumption and/or increases rendering quality.

FIG. 7 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 90 (FIG. 5), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

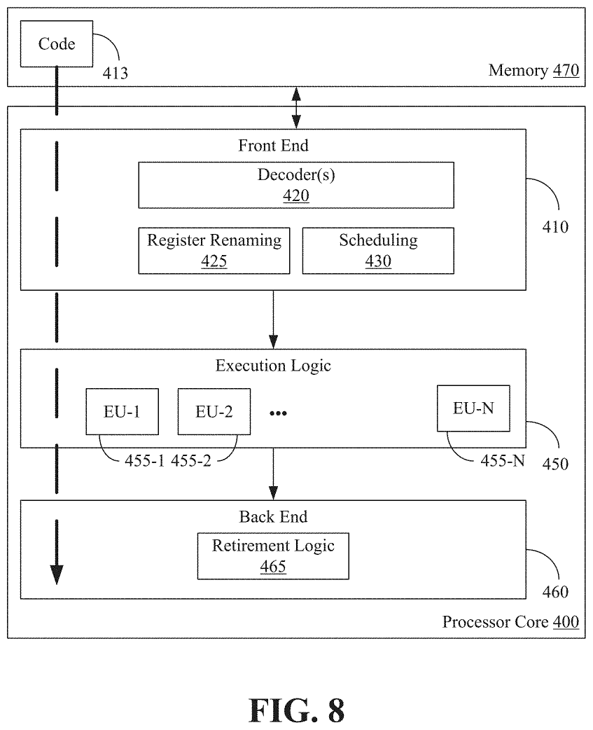

FIG. 8 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 8, a processing element may alternatively include more than one of the processor core 400 illustrated in FIG. 8. The processor core 400 may be a single-threaded core or, for at least one embodiment, the processor core 400 may be multithreaded in that it may include more than one hardware thread context (or “logical processor”) per core.

FIG. 8 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 90 (FIG. 5), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 8, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

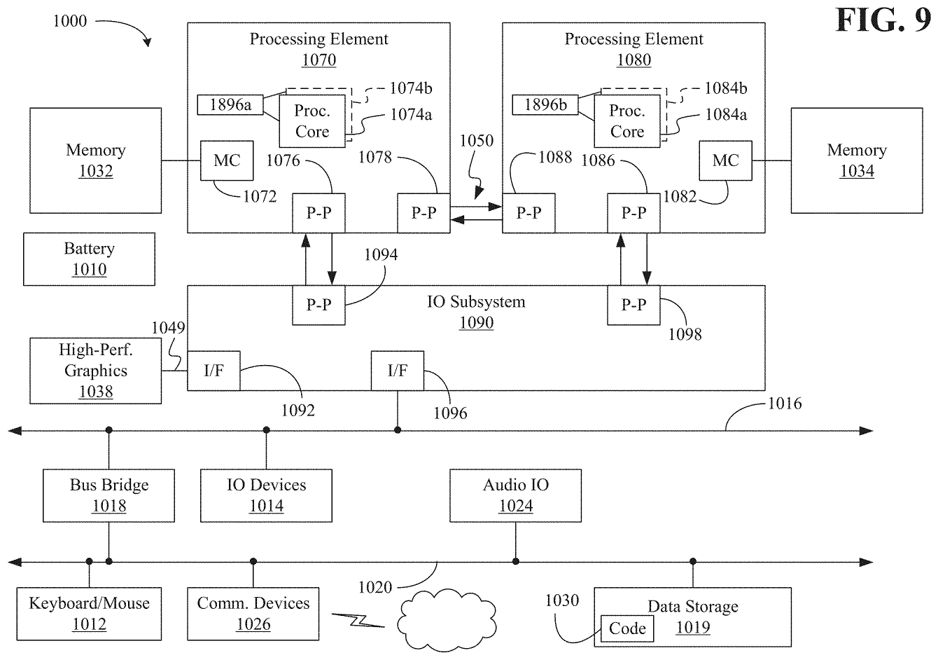

Referring now to FIG. 9, shown is a block diagram of a computing system 1000 embodiment in accordance with an embodiment. Shown in FIG. 9 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 9 may be implemented as a multi-drop bus rather than point-to-point interconnect.

As shown in FIG. 9, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 8.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 9, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 9, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 9, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 90 (FIG. 5), already discussed. Further, an audio I/O 1024 may be coupled to second bus 1020 and a battery 1010 may supply power to the computing system 1000.

Note that other embodiments are contemplated. For example, instead of the point-to-point architecture of FIG. 9, a system may implement a multi-drop bus or another such communication topology. Also, the elements of FIG. 9 may alternatively be partitioned using more or fewer integrated chips than shown in FIG. 9.

### ADDITIONAL NOTES AND EXAMPLES

Example 1 includes a performance-enhanced computing system comprising a network controller, a processor coupled to the network controller, and a memory coupled to the processor, wherein the memory includes a set of instructions, which when executed by the processor, cause the processor to train a first neural radiance field (NeRF) model with first images corresponding to a first instance of a scene, and repeatedly apply generative replay and second images corresponding to a second instance of the scene to the first NeRF model to obtain an updated NeRF model, wherein one or more of appearance changes or geometry changes in the second instance of the scene relative to the first instance of the scene are incorporated into the updated NeRF model.

Example 2 includes the computing system of Example 1, wherein the instructions, when executed, further cause the processor to add trainable embeddings to the second NeRF model, wherein the trainable embeddings handle at least one of the one or more of appearance changes or geometry changes.

Example 3 includes the computing system of any one of Examples 1 to 3, wherein the instructions, when executed, further cause the processor to apply segmentation masks to transient objects in the second instance of the scene.

Example 4 includes the computing system of any one of Examples 1 to 4, wherein the instructions, when executed, further cause the processor to bypass a storage of the first images after the first NeRF model is trained, and bypass a storage of the first NeRF model and the second images after the second NeRF model is obtained.

Example 5 includes the computing system of Example 1, wherein the instructions, when executed, further cause the processor to detect third images corresponding to a third instance of the scene, and apply the generative replay and the third images to the second NeRF model to obtain a third NeRF model, wherein one or more of appearance changes or geometry changes in the third instance of the scene relative to the second instance of the scene are incorporated into the third NeRF model.

Example 6 includes at least one computer readable storage medium comprising a set of instructions, which when executed by a computing system, cause the computing system to train a first neural radiance field (NeRF) model with first images corresponding to a first instance of a scene, detect second images corresponding to a second instance of the scene, and apply generative replay and the second images to the first NeRF model to obtain a second NeRF model, wherein one or more of appearance changes or geometry changes in the second instance of the scene relative to the first instance of the scene are incorporated into the second NeRF model.

Example 7 includes the at least one computer storage medium of Example 6, wherein the instructions, when executed, further cause the computing system to add trainable embeddings to the second NeRF model, wherein the trainable embeddings handle at least one of the one or more of appearance changes or geometry changes.

Example 8 includes the at least one computer readable storage medium of Example 6, wherein the instructions, when executed, further cause the computing system to apply segmentation masks to transient objects in the second instance of the scene.

Example 9 includes the at least one computer readable storage medium of Example 6, wherein the instructions, when executed, further cause the computing system to bypass a storage of the first images after the first NeRF model is trained, and bypass a storage of the first NeRF model and the second images after the second NeRF model is obtained.

Example 10 includes the at least one computer readable storage medium of Example 6, wherein the first NeRF is trained further based on camera parameters associated with the first images, and wherein the instructions, when executed, further cause the computing system to incorporate the camera parameters into the generative replay.

Example 11 includes the at least one computer readable storage medium of any one of Examples 6 to 10, wherein the first images and the second images are to be multi-view images.

Example 12 includes the at least one computer readable storage medium of any one of Examples 6 to 11, wherein the instructions, when executed, further cause the computing system to detect third images corresponding to a third instance of the scene, and apply the generative replay and the third images to the second NeRF model to obtain a third NeRF model, wherein one or more of appearance changes or geometry changes in the third instance of the scene relative to the second instance of the scene are incorporated into the third NeRF model.

Example 13 includes a semiconductor apparatus comprising one or more substrates, and logic coupled to the one or more substrates, wherein the logic is implemented at least partly in one or more of configurable or fixed-functionality hardware, the logic to train a first neural radiance field (NeRF) model with first images corresponding to a first instance of a scene, detect second images corresponding to a second instance of the scene, and apply generative replay and the second images to the first NeRF model to obtain a second NeRF model, wherein one or more of appearance changes or geometry changes in the second instance of the scene relative to the first instance of the scene are incorporated into the second NeRF model.

Example 14 includes the semiconductor apparatus of Example 13, wherein the logic is further to add trainable embeddings to the second NeRF model, wherein the trainable embeddings handle at least one of the one or more of appearance changes or geometry changes.

Example 15 includes the semiconductor apparatus of Example 13, wherein the logic is further to apply segmentation masks to transient objects in the second instance of the scene.

Example 16 includes the semiconductor apparatus of Example 13, wherein the logic is further to bypass a storage of the first images after the first NeRF model is trained, and bypass a storage of the first NeRF model and the second images after the second NeRF model is obtained.

Example 17 includes the semiconductor apparatus of Example 13, wherein the first NeRF is trained further based on camera parameters associated with the first images, and wherein the logic is further to incorporate the camera parameters into the generative replay.

Example 18 includes the semiconductor apparatus of any one of Examples 13 to 17, wherein the first images and the second images are to be multi-view images.

Example 19 includes the semiconductor apparatus of any one of Examples 13 to 18, wherein the logic is further to detect third images corresponding to a third instance of the scene, and apply the generative replay and the third images to the second NeRF model to obtain a third NeRF model, wherein one or more of appearance changes or geometry changes in the third instance of the scene relative to the second instance of the scene are incorporated into the third NeRF model.

Example 20 includes the semiconductor apparatus of any one of Examples 13 to 18, wherein the logic coupled to the one or more substrates includes transistor channel regions that are positioned within the one or more substrates.

Example 21 includes a method of operating a performance-enhanced computing system, the method comprising training a first neural radiance field (NeRF) model with first images corresponding to a first instance of a scene, detecting second images corresponding to a second instance of the scene, and applying generative replay and the second images to the first NeRF model to obtain a second NeRF model, wherein one or more of appearance changes or geometry changes in the second instance of the scene relative to the first instance of the scene are incorporated into the second NeRF model.

Example 22 includes an apparatus comprising means for performing the method of Example 21.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claim

We claim:

1. A computing system comprising:
a network controller;
a processor coupled to the network controller; and
a memory coupled to the processor, wherein the memory includes a set of instructions, which when executed by the processor, cause the processor to:
train a first neural radiance field (NeRF) model with first images corresponding to a first instance of a scene,
detect second images corresponding to a second instance of the scene, and
apply generative replay and the second images to the first NeRF model to obtain a second NeRF model, wherein one or more of appearance changes or geometry changes in the second instance of the scene relative to the first instance of the scene are incorporated into the second NeRF model.

2. The computing system of claim 1, wherein the instructions, when executed, further cause the processor to add trainable embeddings to the second NeRF model, wherein the trainable embeddings handle at least one of the one or more of appearance changes or geometry changes.

3. The computing system of claim 1, wherein the instructions, when executed, further cause the processor to apply segmentation masks to transient objects in the second instance of the scene.

4. The computing system of claim 1, wherein the instructions, when executed, further cause the processor to:
bypass a storage of the first images after the first NeRF model is trained; and
bypass a storage of the first NeRF model and the second images after the second NeRF model is obtained.

5. The computing system of claim 1, wherein the instructions, when executed, further cause the processor to:
detect third images corresponding to a third instance of the scene, and
apply the generative replay and the third images to the second NeRF model to obtain a third NeRF model, wherein one or more of appearance changes or geometry changes in the third instance of the scene relative to the second instance of the scene are incorporated into the third NeRF model.

6. At least one computer readable storage medium comprising a set of instructions, which when executed by a computing system, cause the computing system to:
train a first neural radiance field (NeRF) model with first images corresponding to a first instance of a scene;
detect second images corresponding to a second instance of the scene; and
apply generative replay and the second images to the first NeRF model to obtain a second NeRF model, wherein one or more of appearance changes or geometry changes in the second instance of the scene relative to the first instance of the scene are incorporated into the second NeRF model.

7. The at least one computer storage medium of claim 6, wherein the instructions, when executed, further cause the computing system to add trainable embeddings to the second NeRF model, wherein the trainable embeddings handle at least one of the one or more of appearance changes or geometry changes.

8. The at least one computer readable storage medium of claim 6, wherein the instructions, when executed, further cause the computing system to apply segmentation masks to transient objects in the second instance of the scene.

9. The at least one computer readable storage medium of claim 6, wherein the instructions, when executed, further cause the computing system to:
bypass a storage of the first images after the first NeRF model is trained; and
bypass a storage of the first NeRF model and the second images after the second NeRF model is obtained.

10. The at least one computer readable storage medium of claim 6, wherein the first NeRF is trained further based on camera parameters associated with the first images, and wherein the instructions, when executed, further cause the computing system to incorporate the camera parameters into the generative replay.

11. The at least one computer readable storage medium of claim 6, wherein the first images and the second images are to be multi-view images.

12. The at least one computer readable storage medium of claim 6, wherein the instructions, when executed, further cause the computing system to:
detect third images corresponding to a third instance of the scene; and
apply the generative replay and the third images to the second NeRF model to obtain a third NeRF model, wherein one or more of appearance changes or geometry changes in the third instance of the scene relative to the second instance of the scene are incorporated into the third NeRF model.

13. A semiconductor apparatus comprising:
one or more substrates; and
logic coupled to the one or more substrates, wherein the logic is implemented at least partly in one or more of configurable or fixed-functionality hardware, the logic to:
train a first neural radiance field (NeRF) model with first images corresponding to a first instance of a scene;
detect second images corresponding to a second instance of the scene; and
apply generative replay and the second images to the first NeRF model to obtain a second NeRF model, wherein one or more of appearance changes or geometry changes in the second instance of the scene relative to the first instance of the scene are incorporated into the second NeRF model.

14. The semiconductor apparatus of claim 13, wherein the logic is further to add trainable embeddings to the second NeRF model, wherein the trainable embeddings handle at least one of the one or more of appearance changes or geometry changes.

15. The semiconductor apparatus of claim 13, wherein the logic is further to apply segmentation masks to transient objects in the second instance of the scene.

16. The semiconductor apparatus of claim 13, wherein the logic is further to:
bypass a storage of the first images after the first NeRF model is trained; and
bypass a storage of the first NeRF model and the second images after the second NeRF model is obtained.

17. The semiconductor apparatus of claim 13, wherein the first NeRF is trained further based on camera parameters associated with the first images, and wherein the logic is further to incorporate the camera parameters into the generative replay.

18. The semiconductor apparatus of claim 13, wherein the first images and the second images are to be multi-view images.

19. The semiconductor apparatus of claim 13, wherein the logic is further to:
detect third images corresponding to a third instance of the scene; and
apply the generative replay and the third images to the second NeRF model to obtain a third NeRF model, wherein one or more of appearance changes or geometry changes in the third instance of the scene relative to the second instance of the scene are incorporated into the third NeRF model.

20. The semiconductor apparatus of claim 13, wherein the logic coupled to the one or more substrates includes transistor channel regions that are positioned within the one or more substrates.
